(19) United States
(12) Patent Application Publication
(10) Pub. No.: US 2004/0191024 A1
(43) Pub. Date: Sep. 30, 2004

(54) Toggle bolt

(76) Inventor: George T. Domizio, Stevenson, CT (US)

Correspondence Address: BACHMAN & LAPOINTE, P.C., 900 CHAPEL STREET, SUITE 1201, NEW HAVEN, CT, 06510, US

(21) Appl. No.: 10/811,372

(22) Filed: Mar. 26, 2004

Related U.S. Application Data
(60) Provisional application No. 60/457,764, filed on Mar. 26, 2003.

(51) Int. Cl. F16B 31/00

(52) U.S. Cl. 411/2

(57) ABSTRACT

A toggle bolt for securing a threaded member relative to a mold wall, including a head portion having a central portion, a rounded end extending from one end of the central portion and at least one wing flexibly extending laterally with respect to a longitudinal axis of the central portion; and a thread protector portion including a threaded member having a slotted head, the thread protector being releaseably connected to the central portion.

### CROSS REFERENCE TO PROVISIONAL APPLICATION

This application claims priority to provisional application No. 60/457,764 filed Mar. 26, 2003

### BACKGROUND OF THE INVENTION

The invention relates to a toggle bolt which can advantageously be used to secure a threaded insert on a mold wall before filling the mold with concrete. This is desired so as to locate the threaded insert in a particular location in the resulting precast article.

Positioning of various articles into the material of a molded articles is frequently complicated and difficult, and involves various labor-intensive steps in connection with securing the article relative to the mold and, then, removing any extraneous articles after the molded article has at least partially solidified.

It is the primary object of the present invention to resolve these problems and provide an apparatus whereby an article, especially a threaded insert, can easily be positioned for incorporation into a molded article.

Other objects and advantages of the present invention will appear hereinbelow.

### SUMMARY OF THE INVENTION

In accordance with the present invention, a toggle bolt is provided which has a threaded portion adapted for threadedly securing with a threaded insert or other threaded article to be incorporated into the molded article, and also having a head portion adapted to be secured to the wall of the mold. Advantageously, the head portion and threaded portion of the toggle bolt is adapted for easy breakaway of one component from the other such that, when the mold wall is removed from the article, the head portion breaks away leaving the threaded insert disposed within the molded article as desired, with the threaded portion of the toggle bolt disposed within the insert.

In further accordance with the present invention, a toggle bolt is provided for securing a threaded member relative to a mold wall for a molded article, which toggle bolt comprises a head portion having a central portion, a rounded end extending from one end of the central portion and at least one wing flexibly extending laterally with respect to a longitudinal axis of the central portion; and a thread protector portion comprising a threaded member having a slotted head, the thread protector being releasably connected to the central portion.

In further accordance with the invention, a method is provided for positioning a threaded member in a molded article, comprising the steps of providing a toggle bolt for securing a threaded member relative to a mold wall, comprising a head portion having a central portion, a rounded end extending from one end of the central portion and at least one wing flexibly extending laterally with respect to a longitudinal axis of the central portion; and a thread protector portion comprising a threaded member having a slotted head, the thread protector being releasably connected to the central portion; threading the threaded member onto the thread protector, inserting the head portion into a mold wall of a mold for the molded article, pouring material into the mold so as to form the molded article around the threaded member; and removing the molded article from the mold whereby the head portion breaks away from the thread protector, and the thread protector remains in the threaded member with the slotted head exposed.

### BRIEF DESCRIPTION OF THE DRAWINGS

A detailed description of preferred embodiments of the present invention follows, with reference to the attached drawings, wherein:

FIG. 1 illustrates a toggle bolt and threaded insert in accordance with the present invention;

FIG. 2 illustrates a toggle bolt and threaded insert in accordance with the present invention partially inserted through a hole in a mold wall;

FIG. 3 illustrates a toggle bolt and threaded insert in accordance with the present invention which is tightened onto the wall of the mold;

FIG. 4 illustrates the threaded insert with a portion of the toggle bolt disposed within a molded article, with the mold wall removed from the article and the head portion of the toggle bolt broken away;

FIG. 5 illustrates an end view of the threaded insert with threaded portion of the toggle bolt as disposed within a molded article;

FIG. 6 is a side view of a preferred embodiment of a toggle bolt in accordance with the present invention; and

FIG. 7 is a perspective view of a broken away threaded portion of the embodiment of FIG. 6.

### DETAILED DESCRIPTION

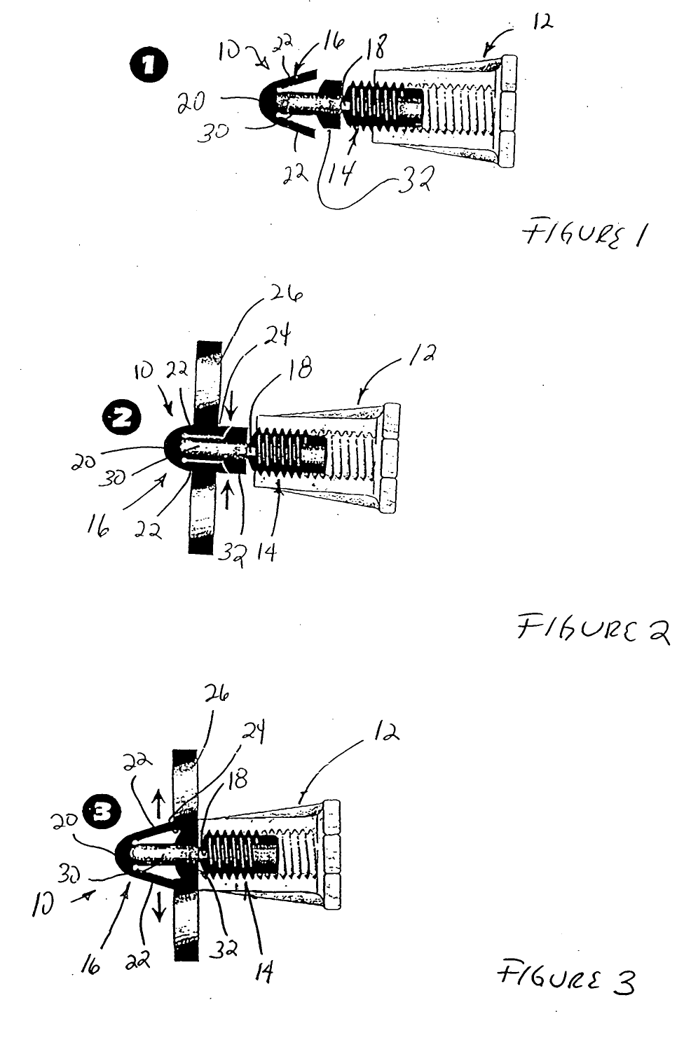

The apparatus in accordance with the present invention further provides for a breakaway portion which leaves a thread protector in the threaded insert after the precast article is removed from the mold. FIGS. 1-5 illustrate a preferred embodiment.

Referring to FIG. 1, a toggle bolt 10 in accordance with the present invention is shown partially threaded into an insert 12.

Toggle bolt 10 according to the invention includes a thread protector portion 14 and a head portion 16 which are releasably connected.

Thread protector portion 14 is preferably a substantially cylindrical-shaped member having threads for matingly inserting into insert member 12, and further preferably having a slotted face 18 which, when head portion 16 is removed, allows for removal and replacement using conventional tools such as a simple screw driver.

Of course, although the illustration of the drawings shows a single slot in thread protector portion 14, which of course would be useful with a conventional flat screw driver, other structure could be positioned on the surface of thread protector portion 14 which is to be exposed, for interacting with different types of tools or implements as well.

Head portion 16 is preferably provided having a substantially rounded tip 20 and wing members 22 which are preferably biased to a partially open position as shown in FIG. 1 and which can be inwardly flexed to the position of FIG. 2 so as to allow head portion 16 to be inserted through an opening 24 in a mold wall 26.

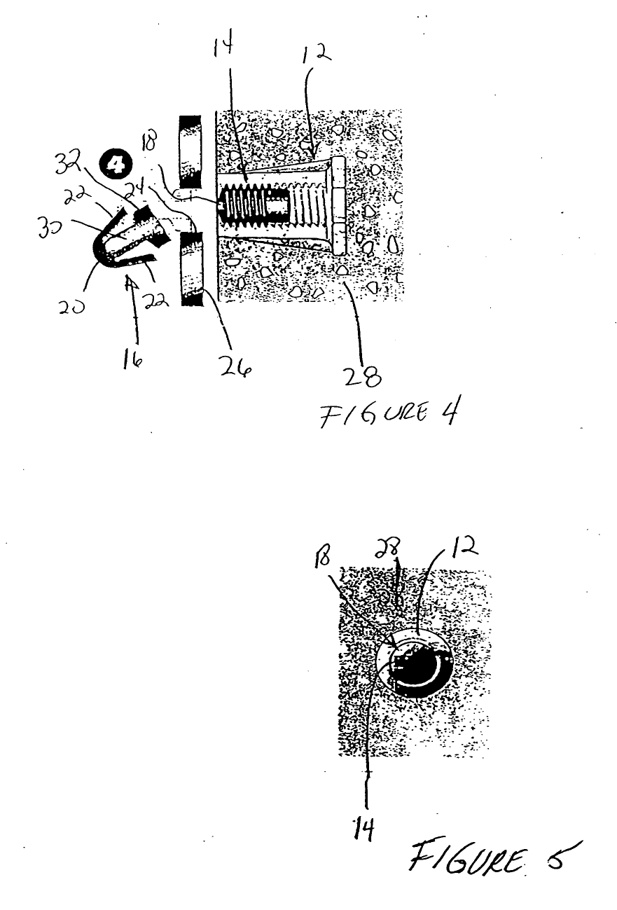

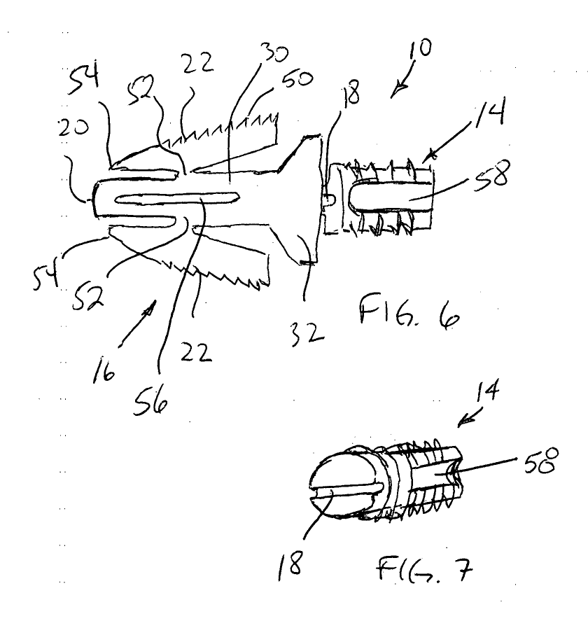

In use, toggle bolt 10 is threaded into a threaded insert 12 as shown in FIG. 1, and is then pushed, for example by hand, through opening 24 in mold wall 26 as shown in FIG. 2. When the wing members 22 of head portion 16 snap open behind mold wall 26, for example as shown in FIG. 3, the insert member 12 is then preferably hand tightened against mold wall 26 and the assembly is now properly installed on mold wall 26 such that concrete can be poured into the mold to form a precast article around threaded insert 12 as shown in FIG. 4. When the product is stripped from the mold or form, or vice versa, head portion 16 breaks away from thread protector 14 leaving insert 12 mounted within precast article 28 as desired and as shown in FIG. 4. FIG. 5 further illustrates the final product, with thread protector 14 mounted in threaded insert 12 with slotted face 18 exposed for use in removing thread protector 14 as desired.

Toggle bolt 10 in accordance with the present invention is preferably provided of any suitable material, for example any of a number of suitable plastic materials, which provide for the desired flexibility of wing members 22 relative to head portion 16 along with the desired breakability in the connection between head portion 16 and thread protector 14.

Referring to FIGS. 1-5 together, it is preferred that head portion 16 be provided having a central body portion 30 with a substantially solid base portion 32 and with wing members 22 extending rearwardly, towards base portion 32, from rounded tip 20. Central body portion 30 advantageously serves to fill opening 24 in mold wall 26 so as to provide stability of mounting of the device, and further to provide improved seal so as to prevent escape of concrete during filling of the mold.

This represents a substantial improvement over conventional methods for securing threaded inserts to walls of concrete molds or forms.

Turning now to FIGS. 6 and 7, an alternative embodiment is illustrated.

FIG. 6 shows a toggle bolt 10 similar to that of FIGS. 1-5 having elements as referenced above. In this embodiment, however, a plurality of ridges 50 are advantageously positioned on an outer surface of wings 22 and advantageously serve to assist in holding head portion 16 within an opening in a mold wall as desired. Ridges 50 can be positioned along an outer surface of either or both of wings 22 as desired.

FIG. 6 further illustrates an embodiment in accordance with the present invention wherein wings 22 do not extend rearwardly from head 20, but rather wherein wings 22 are flexibly mounted to body portion 30 at hinged connection points 52 which are shown in the drawings. Connection points 52 are advantageously positioned sufficiently close to head 20 that the trailing edges of wings 22 are sufficiently flexible to allow deflection as the toggle bolt 10 is being positioned into a hole into a mold wall. This connection also further advantageously allows inward flexing of the leading portions 54 of wings 22 to assist in initial entry of this portion of the toggle bolt into an opening in the mold wall as well. Thus, due to connection point 52, wing portions 22 can first flex inwardly at the lead portions 54 during initial entry into the opening, and then trailing edges of wings 22 can deflect inwardly as the toggle bolt is positioned further into the opening.

In further accordance with the invention, a slot 56 can advantageously be provided in head portion 16 of toggle bolt 10, and this slot 56 advantageously serves to conserve material and further provide additional flexibility of wings 22 as desired.

Still referring to the embodiment of FIG. 6, thread protector 14 is as described above, and can further advantageously be provided having a cut-out 58 in the body portion thereof, which can extend longitudinally along a substantial portion of the length of thread protector 14 as shown. The cut-out 58 should not extend all the way to slot 18, since this would allow concrete into the threaded insert during molding, which is not desired. Cut-out 58 advantageously serves to conserve material from which toggle bolt 10 is made, and also provides a sharp edge along a portion of the threads of thread protector 14, which can advantageously scrape any debris or any other material from the inside surface of the threaded insert, whereby positioning thread protector 14 into and out of the threaded member can advantageously clean the threads of same.

FIG. 7 further illustrates the structure discussed above in connection with thread protector 14, and further shows slotted head 18, cut-outs 58 and the threads of thread protector 14 which are used to threadly engage the insert member as desired.

It should of course be appreciated that the embodiment shown and described herein is a description of one embodiment of the present invention, and modification as to various shapes and sizes of particular elements of the device can of course be made by a person of ordinary skill in the art well within the scope of the present invention.

What is claimed:

1. A toggle bolt for securing a threaded member relative to a mold wall, comprising:
a head portion having a central portion, a rounded end extending from one end of the central portion and at least one wing flexibly extending laterally with respect to a longitudinal axis of the central portion; and
a thread protector portion comprising a threaded member having a slotted head, the thread protector being releaseably connected to the central portion.

2. The apparatus of claim 1, wherein the central portion has a solid base at an end opposite to the rounded end, and wherein the slotted head of the thread protector is releasbly connected to the solid base.

3. The apparatus of claim 1, wherein the at least one wing comprises at least two wings extending laterally from opposite sides of the central portion.

4. The apparatus of claim 1, wherein the at least one wing has an outer surface, and ridges on the outer surface.

5. The apparatus of claim 1, further comprising a longitudinal slot disposed along the central portion.

6. The apparatus of claim 1, wherein the at least one wing extends outerwardly and rearwardly from the rounded head.

7. The apparatus of claim 1, wherein the at least one wing is hingedly mounted to the central portion at a hinged connection.

8. The apparatus of claim 7, wherein a forward facing portion of the at least one wing extends forward from the hinge connection, and a rearward facing portion of the at least one wing extends rearwardly from the hinge connection.

9. The apparatus of claim 1, further comprising at least one longitudinal cutout positioned along the thread protector.

10. The apparatus of claim 9, wherein the at least longitudinal cutout extends from a rear edge of the thread protector toward the slotted head.

11. The apparatus of claim 10, wherein the longitudinal cut out ends before reading the slotted head.

12. A method for positioning a threaded member in a molded article, comprising the steps of:
providing a head portion having a central portion, a rounded end extending from one end of the central portion and at least one wing flexibly extending laterally with respect to a longitudinal axis of the central portion; and
a thread protector portion comprising a threaded member having a slotted head, the thread protector being releaseably connected to the central portion;
threading the threaded member onto the thread protector;
inserting the head portion into a mold wall of a mold for the molded article;
pouring material into the mold so as to form the molded article around the threaded member; and
removing the molded article from the mold whereby the head portion breaks away from the thread protector, and the thread protector remains in the threaded member with the slotted head exposed.
